(19) United States
(12) Patent Application Publication
(10) Pub. No.: US 2003/0131317 A1
(43) Pub. Date: Jul. 10, 2003

(54) Method and system for organizing non-document specifications

(76) Inventors: Phyllis R. Budka, Niskayuna, NY (US); Jill Kallsen, Thomaston, CT (US)

Correspondence Address: PERKINS COIE LLP, PATENT-SEA, P.O. BOX 1247, SEATTLE, WA, 98111-1247, US

(21) Appl. No.: 10/042,191

(22) Filed: Jan. 9, 2002

(51) Int. Cl. G06F 15/00

(52) U.S. Cl. 715/514

(57) ABSTRACT

A method and system for organizing non-document information based on an organization of documents. An information management system provides a hierarchical organization of non-document information relating to web sites and experts using the same hierarchical organization that is used for documents. The information management system stores the non-document specifications in a non-document specifications store, such as a database. The information management system allows users to access the non-document specifications using the hierarchical organization.

### BACKGROUND

The described technology relates to computer-based information management systems and, in particular, to information management systems for hierarchically organized, non-document information.

Various entities, such as corporations, educational institutions, and non-profit organizations generate or collect vast numbers of electronic and non-electronic documents. In order to track and manage such documents, some entities have developed formalized document management procedures to ensure that such documents are organized and easily accessible. For example, a company may have a documentation group with responsibility to collect, maintain, and publish all the necessary documentation for equipment sold by that company. That documentation may be generated by the company itself (i.e., internal documents) or by outside suppliers (i.e., external documents) who provide services or equipment to the company. Such a company may use a specialized document naming scheme to organize these non-electronic and electronic documents. One such naming scheme assigns a document identifier to each document. The identifier is of the format “ANAN” where A represents an alphabetical character and N represents a numeric character. For example, a valid document identifier might be “B6D8.” These identifiers are hierarchical in nature. For example, the first character (e.g., “B”) may represent a type of material (e.g., metallic), the second character (e.g., “6”) may represent a division of the company, the third character (e.g., “D”) may represent a type of equipment (e.g., aircraft), and the fourth character (e.g., “8”) may represent a certain type of document for that equipment. The documentation group may keep manual and electronic copies of these documents organized by their identifier so that the documents can be located and copied when needed. An electronic document is generally considered to be a collection of text and graphics related to a certain subject that is stored in a single computer file.

These entities may also use, generate, or collect vast amounts of non-document information. This non-document information may include supplier information, customer information, useful web sites, expert lists, and so on. Some entities may try to organize such non-document information by maintaining, for example, a list of experts organized alphabetically or a list of customers organized by standard industrial classification (“SIC”) codes. Such organizations are problematic for several reasons. First, because each type of information (e.g., expert list and customer list) is typically organized using different schemes, it is difficult for users to become familiar with these different schemes and to correlate information stored using one scheme with information stored using another scheme. For example, a list of experts organized alphabetically may be difficult to correlate with companies organized using SIC codes. Second, it may be difficult and time consuming to develop new organizational schemes as new information is generated or collected. For example, a company may organize web sites by SIC codes to help users locate web sites of interest. Such an organization, however, does not allow for easy correlation of such web sites with documents that may be organized in a completely different way. It would be desirable to have a method and system for organizing document and non-document information in a way that would reduce these problems.

(Because the technology described in the Detailed Description section is in one embodiment, the World Wide Web environment, an overview of that environment is provided.) Because it facilitates electronic communications between companies, suppliers, and customers, the Internet is increasingly being used to conduct “electronic commerce.” The Internet comprises a vast number of computers and computer networks that are interconnected through communication links. Electronic commerce refers generally to commercial transactions that are at least partially conducted using the computer systems of the parties to the transactions. For example, a company representative can use a personal computer to connect via the Internet to a supplier's computer. The representative can then interact with the supplier's computer to retrieve needed information. The World Wide Web portion of the Internet is especially conducive to conducting electronic commerce. Many web servers have been developed through which suppliers and companies can make information on their product available through a web site. The products can include items (e.g., product description) that are delivered electronically to the company over the Internet and items (e.g., equipment) that are delivered through conventional distribution channels (e.g., a common carrier). A server computer system may provide an electronic version of a catalog that lists the items that are available. A user may browse through the catalog using a browser and select various items available to be accessed.

### BRIEF DESCRIPTION OF DRAWINGS

FIG. 1 illustrates a document hierarchy in one embodiment.

FIG. 2 illustrates a web page for browsing through the hierarchy of non-document specifications in one embodiment.

FIG. 3 illustrates a web page for displaying web site and expert specifications in one embodiment.

FIG. 4 illustrates a web page for updating associations between categories and web site and expert specifications in one embodiment.

FIG. 5 is a block diagram illustrating components used to implement the information management system in one embodiment.

FIG. 6 is a flow diagram illustrating the processing of the view component when a request is received to select a category of the hierarchy in one embodiment.

FIG. 7 is a flow diagram illustrating the processing of the view component when a request for web site and expert specification is received in one embodiment.

FIG. 8 is a flow diagram illustrating the processing of the administration component when a request for web site and expert specifications is received in one embodiment.

FIG. 9 is a flow diagram illustrating the processing of the administration component when a request to update web site and expert specifications is received in one embodiment.

### DETAILED DESCRIPTION

A method and system for organizing non-document information based on an organization of documents is provided. In one embodiment, an information management system provides a hierarchical organization of non-document information relating to web sites and experts using the same hierarchical organization that is used for documents. The information management system provides a hierarchical organization that specifies topmost categories, intermediate categories, and bottommost categories based on the hierarchical organization that is used for documents. The information management system receives associations of non-document specifications with the bottommost categories. For example, a bottommost category may be “chromium-molybdenum steel” and the non-document specification may be the name and telephone number of an expert. The information management system stores the non-document specifications in a non-document specifications store, such as a database. For example, web site specifications may be stored in a web sites store, and expert specifications may be stored in an experts store. The information management system allows users to access the non-document specifications using the hierarchical organization. The information management system may allow users to browse through the hierarchical organization and select a bottommost category. The information management system then retrieves the non-document specifications associated with the selected bottommost category and provides the retrieved non-document specifications to the user. Thus, the user has access to non-document specifications using a hierarchical organization that is based on a hierarchical organization of documents with which the user may be familiar. In this way, a user can retrieve document and non-document specifications using the same hierarchical organization and easily determine whether the specifications and documents are related.

In an alternate embodiment, the information management system may allow the non-document specifications to be associated with non-bottommost categories. When a user selects a non-bottommost category, the information management system may provide the user with the non-document specifications associated only with that selected non-bottommost category. Alternatively, the information management system may provide the user with the non-document specifications associated with the selected non-bottommost category and all its subcategories. Moreover, even if the information management system does not allow non-document specifications to be associated with non-bottommost categories, the information management system may provide the user with the non-document specifications associated with all of its subcategories (i.e., descendent categories). A non-document specification is directly associated with one category and indirectly associated with all super-categories (i.e., ancestor categories) of that category. One skilled in the art will appreciate that a non-document specification can be directly associated with multiple categories. For example, an expert in the area of chromium-molybdenum steel may also be an expert in chromium-aluminum steel.

In one embodiment, the non-document specifications provide information related to various web sites and experts. A non-document specification relating to a web site may include the uniform resource locator (“URL”), a description of the web site, and the name of the person responsible for maintaining the web site. A non-document specification relating to experts may include the name of the expert, the electronic mail address of the expert, the telephone number of the expert, and a URL for a web page that provides more information related to the expert.

One skilled in the art will appreciate that a particular implementation of an information management system may include many different options and aspects. For example, the information management system may use a document organizational scheme that is not hierarchical. Also, the information management system may allow for the association of key words or attributes with non-document specifications to facilitate the locating of the specification without using the organizational scheme. For example, an attribute of “rating” may be used to indicate the quality of an expert. The information management system may allow a user to search using various combinations of attribute values and categories. The information management system may provide an administration component for associating non-document specifications with categories of the hierarchy. The administration component may allow a user to specify that a non-document specification is directly associated with multiple categories. Also, the administration component may automatically associate non-document specifications based on semantic analysis of the specification using, for example, information retrieval technology.

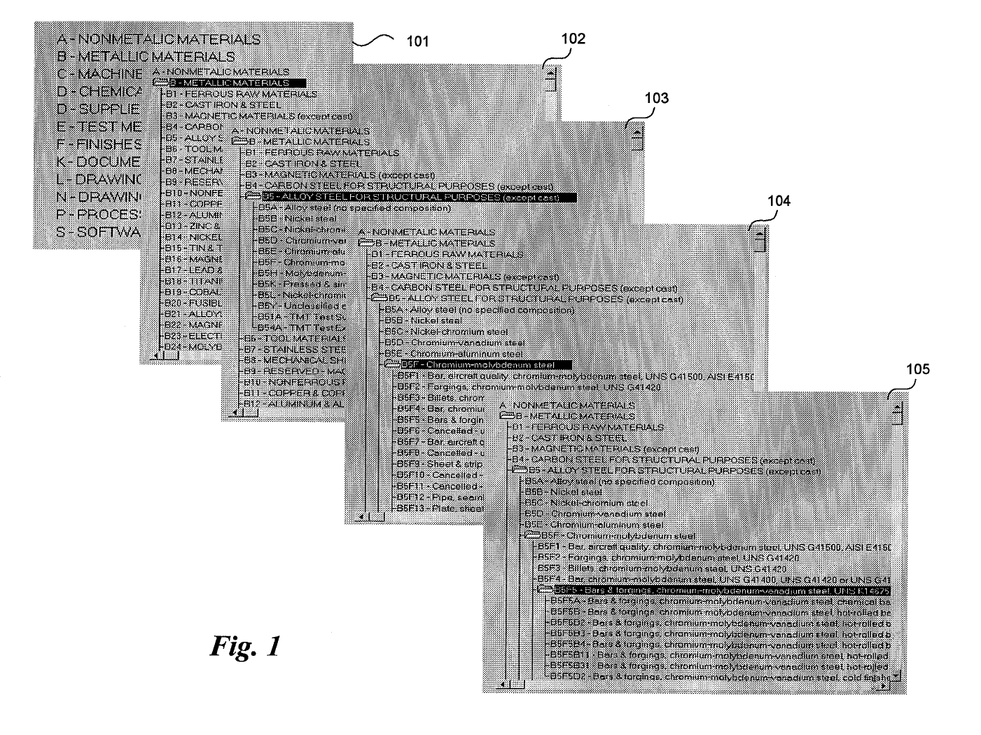

FIG. 1 illustrates a document hierarchy in one embodiment. List 101 corresponds to the topmost categories. The topmost categories include category “A” for nonmetallic materials and category “B” for metallic materials. List 102 corresponds to subcategories for category “B.” The subcategories of category “B” include category “B1” for ferrous raw materials and category “B5” for alloy steel for structural purposes. List 103 corresponds to subcategories of category “B5.”The subcategories of category “B5” include category “B5F” for chromiummolybdenum steel. List 104 may correspond to documents within category “B5F,” and list 105 may correspond to classes within a document. In one embodiment, the information management system uses the first three levels of this document hierarchy to organize the non-document specifications.

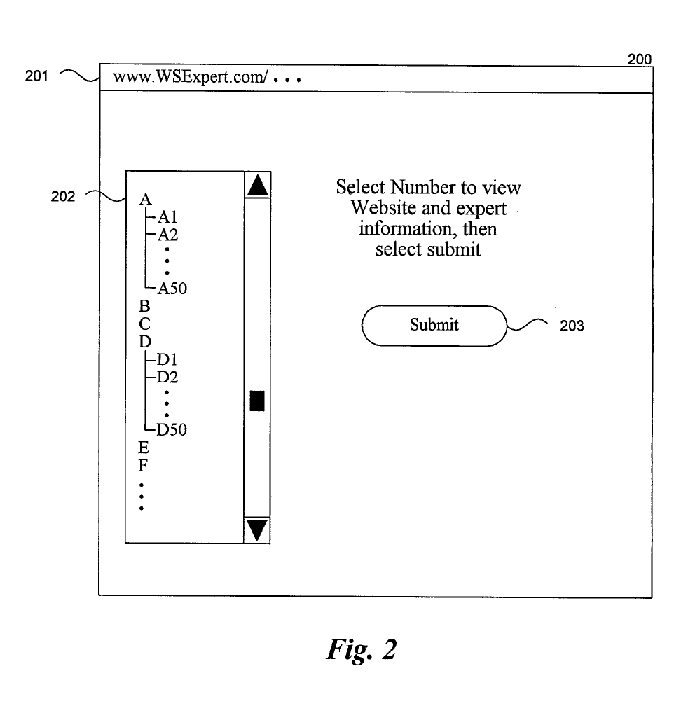

FIGS. 2-4 illustrate web pages of the information management system in one embodiment. In this embodiment, the information management system is implemented in a client/server environment using the Internet. FIG. 2 illustrates a web page for browsing through the hierarchy of non-document specifications in one embodiment. Web page 200 includes an address area 201, a scroll box 202, and a submit button 203. The address area indicates the URL associated with the web page. The scroll box includes an expandable version of the hierarchy. A user may select a category within the hierarchy to display the subcategories of that category. For example, a user may select the category “D” to display its subcategories of “D1,” “D2,” and so on. In an alternate embodiment, the scroll box may include the textual description associated with each category (e.g., “Metallic Materials” for category “B”). The scroll bar includes the scroll buttons and a scroll thumb that may be used in a conventional manner for scrolling through the list of categories and subcategories. A user selects the “submit” button to retrieve the web site and expert specifications related to the currently selected category. For example, if category “B” is selected, then the information management system may display all web site and expert specifications associated with category “B” and its subcategories.

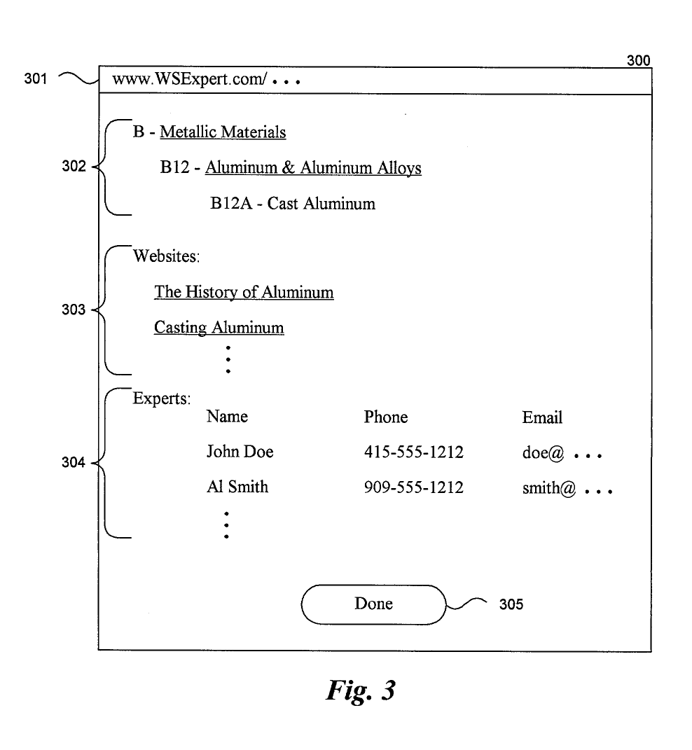

FIG. 3 illustrates a web page for displaying web site and expert specifications in one embodiment. Web page 300 includes an address area 301, a category selection area 302, a web site specification area 303, an expert specification area 304, and a “done” button 305. The address area indicates the URL associated with the web page. The category selection area contains the currently selected category along with its ancestor categories. In this example, category “B12A” is currently selected and its ancestor categories are category “B12” and category “B.” The web site specification area and the expert specification area contain specifications for category “B12A” relating to cast aluminum. The web site specification area contains links to web sites identified by “The History of Aluminum” and “Casting Aluminum.” A user selects one of the links to retrieve information from that web site. The expert specification area contains the name, phone number, and electronic mail address of various experts on cast aluminum. One skilled in the art will appreciate that the expert specification area may contain more detailed information about an expert, such as a link to a web page with the resume of the expert, comments from other users who have used that expert, and so on. In one embodiment, a user may select an ancestor category of the currently selected category to view web site and expert specifications related to that ancestor category. For example, the user may select the category “B” listed in the category selection area to view all web site and expert specifications related to metallic materials. The user selects the “done” button when review of the web site and expert specifications is complete.

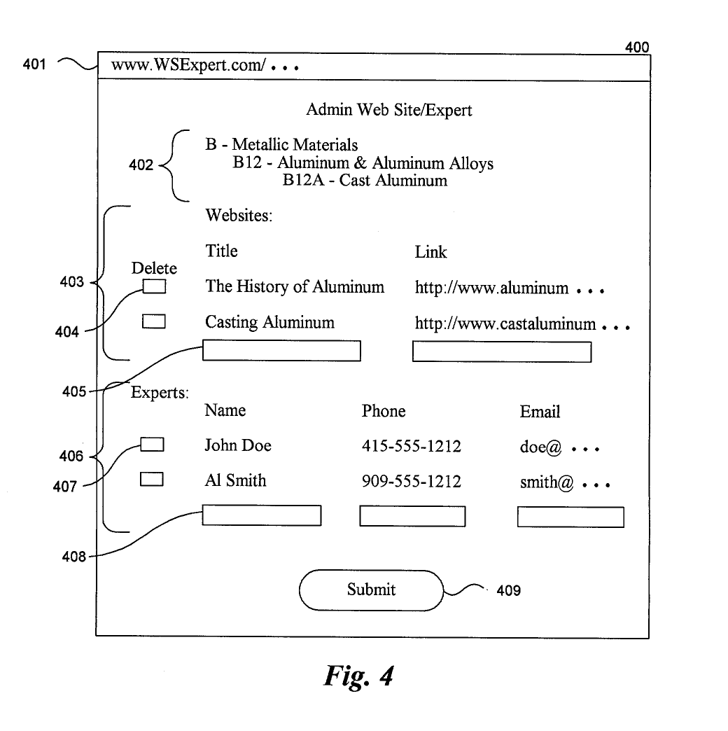

FIG. 4 illustrates a web page for updating associations between categories and web site and expert specifications in one embodiment. Web page 400 may be accessible only by administrative personnel of a company in one embodiment or may be accessible by any user in another embodiment. Web page 400 includes an address area 401, a category selection area 402, a web site maintenance area 403, an expert maintenance area 406, and a submit button 409. The address area contains the URL associated with the web page. The category selection area contains the currently selected category along with its ancestor categories. The web site maintenance area displays web site specifications currently associated with the selected category (i.e., category “B12A” relating to cast aluminum). The web site maintenance area may include delete checkboxes 404 to indicate that a web site specification is to be deleted and may include a data entry area 405 for associating a web site specification with the selected category. The expert maintenance area displays the expert specifications currently associated with the selected category. The expert maintenance area may include delete checkboxes 407 to indicate that an expert specification is to be deleted and may include a data entry area 408 for associating a new expert specification with the selected category. The user selects the submit button to indicate completion of the updating. One skilled in the art will appreciate that many different functional organizations of these web pages may be used. For example, web site specifications and expert specifications may be displayed on separate web pages or web site specifications and expert specifications may be displayed on the same web page along with documents for the selected category.

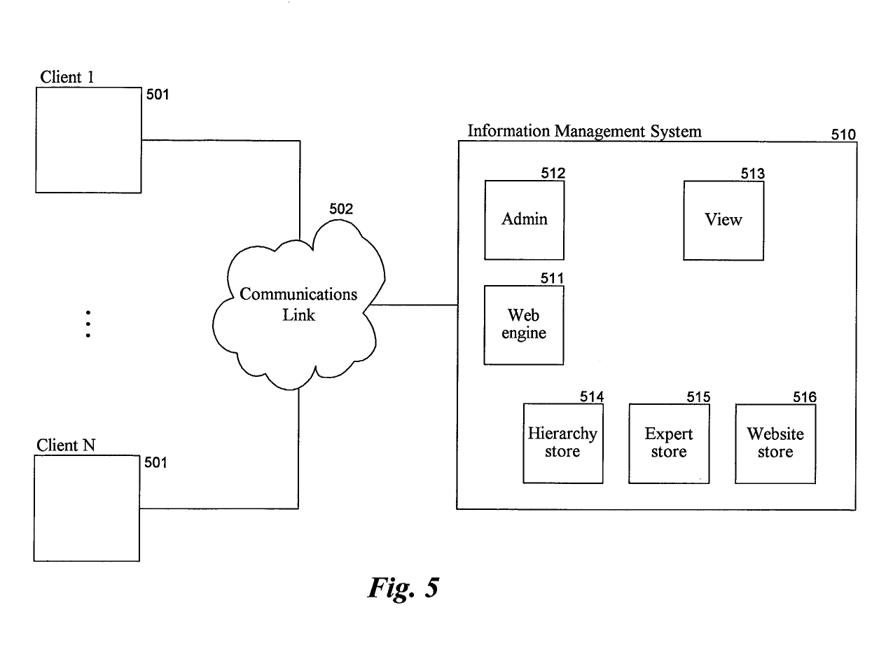

FIG. 5 is a block diagram illustrating components used to implement the information management system in one embodiment. The client computers 501 and the information management system server computer 510 are interconnected via a communications link 502. The computers may each include a central processing unit, memory, input devices (e.g., keyboard and pointing devices), output devices (e.g., display devices), and storage devices (e.g., disk drives). The memory and storage devices are computer-readable media that may contain instructions that implement the information management system. In addition, the data structures and message structures may be stored or transmitted via a data transmission medium, such as a signal on a communications link. Various communications links may be used, such as the Internet, an extranet, or intranet, a local area network, a wide area network, or a point-to-point dial-up connection. The client computers may each include a conventional browser for viewing web pages. The information management system server 510 includes a web engine 511, an administration component 512, a view component 513, a hierarchy store 514, an expert store 515, and a web site store 516. The web engine receives requests from client computers, invokes the appropriate components for processing the requests, and coordinates sending the responses to the client computers. In one embodiment, the requests and responses are HTTP requests and responses. The administration component provides the capability to update the hierarchy, expert, and web site stores. The administration component may be accessible only to privileged users who are responsible for maintaining the stores 514-516. The administration component provides the web page of FIG. 4. The view component provides the capability for users to view the web site specifications and expert specifications associated with a category. The view component provides the web pages of FIGS. 2 and 3. The hierarchy store contains the hierarchical information that is derived from the document hierarchy. The expert store contains the expert specifications and associations with categories. The expert store may be organized hierarchically and in a manner similar to the hierarchy store or may contain mappings from expert specifications to the corresponding categories within the hierarchy. The web site store contains web site specifications and may be organized in the same manner as the expert store. These stores may be organized as a database, flat files, and so on.

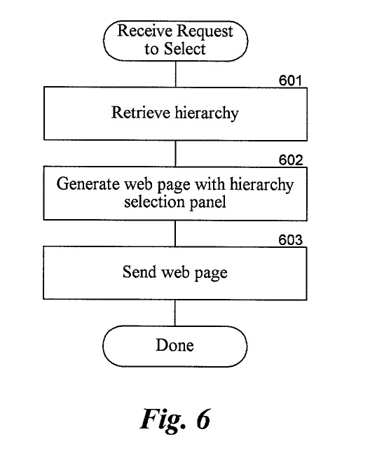

FIGS. 6-9 are flow diagrams illustrating processing of various components of the information management system in one embodiment. FIG. 6 is a flow diagram illustrating the processing of the view component when a request is received to select a category of the hierarchy in one embodiment. The request may be an HTTP request that is forwarded to the view component by the web engine. The view component generates a web page including the hierarchy scroll box and sends that web page to the requesting user. In block 601, the component retrieves the hierarchy from the hierarchy store. In block 602, the component generates the web page that contains the hierarchy scroll box and the submit button. In block 603, the component sends the generated web page as an HTTP response to the requesting user and then completes.

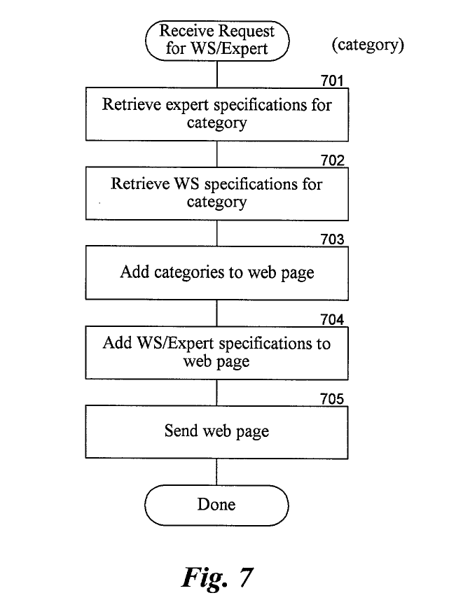

FIG. 7 is a flow diagram illustrating the processing of the view component when a request for web site and expert specification is received in one embodiment. The request may be an HTTP request forwarded to the view component by the web engine. The request includes the identification of the selected category. In block 701, the component retrieves the expert specifications for the selected category from the expert store. In block 702, the component retrieves the web site specifications for the selected category from the web site store. In block 703, the component adds the selected category and its ancestor categories to a web page. In block 704, the component adds the retrieved expert specifications and web site specifications to the web page. In block 705, the component sends the generated web page as an HTTP response to the requesting user and then completes.

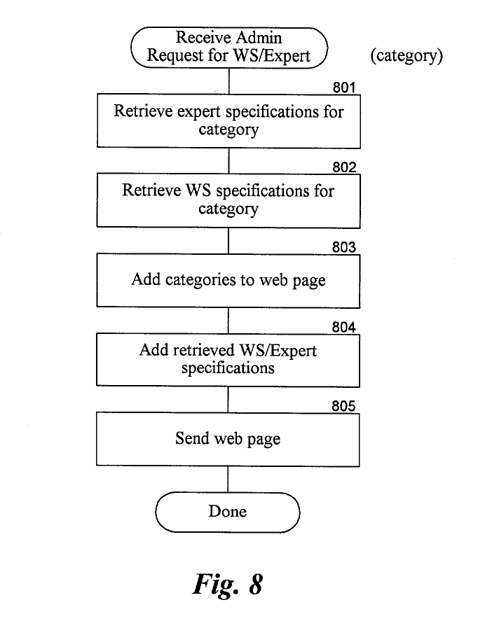

FIG. 8 is a flow diagram illustrating the processing of the administration component when a request for web site and expert specifications is received in one embodiment. The HTTP request is forwarded by the web engine to the administration component. The request includes a category within the hierarchy that was selected by the user. The component generates a web page for maintaining the web site and expert specifications associated with that category. In block 801, the component retrieves the expert specifications for the selected category from the expert store. In block 802, the component retrieves the web site specifications for the selected category from the web site store. In block 803, the component adds the selected category and its ancestor categories to the web page. In block 804, the component adds the retrieved expert specifications and web site specifications to the web page. In block 805, the component sends that web page as an HTTP response to the requesting user and then completes.

FIG. 9 is a flow diagram illustrating the processing of the administration component when a request to update web site and expert specifications is received in one embodiment. The component receives from the web engine an HTTP request that includes a category and update information. The component updates the web site store and expert store accordingly. In block 901, the component deletes any web site specifications associated with the selected category as indicated in the request. In block 902, the component deletes any expert specifications associated with the selected category as indicated in the request. In block 903, the component adds any web site specifications associated with the selected category as indicated in the request. In block 904, the component adds any expert specifications associated with the selected category as indicated in the request. In block 905, the component generates an updated web page that reflects the updates to the expert specifications and web site specifications for the selected category. In block 906, the component sends the web page as an HTTP response to the user and then completes.

From the foregoing, it will be appreciated that although specific embodiments of the information management system have been described herein for purposes of illustration, various modifications may be made without deviating from the spirit and scope of the invention. Accordingly, the invention is not limited except by the appended claims.

1. A method in a computer system for organizing web site and expert information, the method comprising:
providing a hierarchical organization, the hierarchical organization specifying topmost categories, intermediate categories, and bottommost categories;
receiving for a plurality of bottommost categories a specification of a web site and a specification of an expert;
storing in a web site store the received specifications of web sites in association with the bottommost categories;
storing in an expert store the received specifications of experts in association with the bottommost categories;
receiving from a user a bottommost category;
retrieving from the web site store the specification of a web site associated with the received bottommost category;
retrieving from the expert store the specification of an expert associated with the received bottommost category; and
sending to the user the retrieved specification of the web site and the retrieved specification of the expert.

2. The method of claim 1 wherein the hierarchical organization is used to organize documents.

3. The method of claim 1 including
receiving from the user a non-bottommost category;
retrieving from the web site store the specifications of web sites associated with bottommost categories within the received non-bottommost category;
retrieving from the expert store the specifications of experts associated with bottommost categories within the received non-bottommost category; and
sending to the user the retrieved specifications of the web sites and the retrieved specifications of the experts.

4. The method of claim 1 including
receiving for a plurality of non-bottommost categories a specification of a web site and a specification of an expert;
storing in a web site store the received specifications of web sites in association with the non-bottommost categories; and
storing in an expert store the received specifications of experts in association with the non-bottommost categories.

5. The method of claim 4 including
receiving from the user a non-bottommost category;
retrieving from the web site store the specification of a web site associated with the received non-bottommost category;
retrieving from the expert store the specification of an expert associated with the received non-bottommost category; and
sending to the user the retrieved specification of the web site and the retrieved specification of the expert.

6. The method of claim 5 wherein only the specifications directly associated with the received non-bottommost category are retrieved.

7. The method of claim 5 wherein all specifications indirectly associated with the received non-bottommost category are retrieved.

8. The method of claim 1 wherein the specification of a web site includes a URL for the web site.

9. The method of claim 1 wherein the specification of an expert includes a name for the expert.

10. The method of claim 1 wherein the specification of an expert includes an electronic mail address for the expert.

11. The method of claim 1 wherein the specification of an expert includes a telephone number for the expert.

12. The method of claim 1 wherein the specification of an expert includes a URL for a web page containing information relating to the expert.

13. A method in a computer system for managing non-document specifications based on a hierarchy of documents, the method comprising:
providing a hierarchical organization of documents;
providing a hierarchical organization of non-document specifications based on the provided hierarchical organization of documents;
receiving a category within the hierarchical organization;
retrieving non-document specifications associated with the received category; and
sending the retrieved non-document specifications associated with the received category
wherein non-document specifications are hierarchically organized using the same hierarchy used to organize documents.

14. The method of claim 13 wherein the non-document specifications include web site specifications.

15. The method of claim 13 wherein the non-document specifications include expert specifications.

16. The method of claim 13 including retrieving documents associated with the received category and sending the retrieved documents along with the retrieved non-document specifications.

17. The method of claim 13 wherein a non-document specification includes an attribute for use in searching for non-document specifications.

18. The method of claim 13 wherein the category is received from a user and the retrieved non-document specifications are sent to the user.

19. The method of claim 13 wherein the providing of a hierarchy of non-document specifications includes receiving a category and a non-document specification from a user.

20. The method of claim 13 wherein the providing of a hierarchy of non-document specifications includes receiving from a user a non-document specification along with multiple categories with which the non-document specification is associated.

21. The method of claim 13 wherein non-document specifications are associated with bottommost categories.

22. The method of claim 13 wherein non-document specifications are associated with bottommost and non-bottommost categories.

23. The method of claim 13 wherein non-document specifications include web site and expert specifications.

24. The method of claim 13 wherein, when the received category is a non-bottommost category, retrieving non-document specifications associated indirectly with the non-bottommost category.

25. The method of claim 13 wherein, when the received category is a non-bottommost category, retrieving only non-document specifications associated directly with the non-bottommost category.

26. The method of claim 13 wherein the non-document specification includes a URL for a web site.

27. The method of claim 26 wherein the web site is internal to an entity that provides the hierarchical organization.

28. The method of claim 26 wherein the web site is external to an entity that provides the hierarchical organization.

29. The method of claim 13 wherein the non-document specification includes a name of an expert.

30. The method of claim 13 wherein the non-document specification includes an electronic mail address of an expert.

31. The method of claim 13 wherein the non-document specification includes a telephone number of an expert.

32. The method of claim 13 wherein the non-document specification includes a URL for a web page containing information relating to an expert.

33. The method of claim 13 wherein the sending includes sending web site specifications, expert specifications, and documents associated with the received category.

34. A method in a computer system accessing non-document specifications, the method comprising
coordinating browsing by a user through a hierarchical organization of non-document specifications, the hierarchical organization being based on a hierarchical organization of documents;
receiving from the user a selection of a category within the hierarchical organization;
requesting non-document specifications associated with the selected category;
receiving the requested non-document specifications; and
displaying to the user the received non-document specifications.

35. The method of claim 34 wherein the non-document specifications include web site specifications.

36. The method of claim 34 wherein the non-document specifications include expert specifications.

37. The method of claim 34 including receiving documents associated with the selected category and displaying the received documents along with the received non-document specifications.

38. The method of claim 34 wherein the requesting includes sending a request to a server computer system and the receiving of the requested non-document specifications includes receiving from the server computer system.

39. The method of claim 34 wherein non-document specifications are associated with bottommost categories.

40. The method of claim 34 wherein non-document specifications are associated with bottommost and non-bottommost categories.

41. The method of claim 34 wherein non-document specifications include web site and expert specifications.

42. The method of claim 34 wherein, when the selected category is a non-bottommost category, the received non-document specifications include those associated indirectly with the non-bottommost category.

43. The method of claim 34 wherein, when the received category is a non-bottommost category, the non-document specification includes only those directly associated with the non-bottommost category.

44. The method of claim 34 wherein the non-document specification includes a URL for a web site.

45. The method of claim 44 wherein the web site is internal to an entity that provides the hierarchical organization.

46. The method of claim 44 wherein the web site is external to an entity that provides the hierarchical organization.

47. The method of claim 34 wherein the non-document specification includes a name of an expert.

48. The method of claim 34 wherein the non-document specification includes an electronic mail address of an expert.

49. The method of claim 34 wherein the non-document specification includes a telephone number of an expert.

50. The method of claim 34 wherein the non-document specification includes a URL of a web page containing information relating to an expert.

51. The method of claim 34 wherein the displaying includes displaying web site specifications, expert specifications, and documents associated with the selected category on a single web page.

52. A computer-readable medium containing instructions for controlling a computer system to manage non-document specifications based on a hierarchy of documents, by a method comprising:
receiving a category within the hierarchical organization;
retrieving non-document specifications associated with the received category, the non-document specifications being hierarchically organized into categories based on a hierarchical organization of documents; and
sending the retrieved non-document specifications associated with the received category.

53. The computer-readable medium of claim 52 wherein the non-document specifications include web site specifications.

54. The computer-readable medium of claim 52 wherein the non-document specifications include expert specifications.

55. The computer-readable medium of claim 52 including retrieving documents associated with the received category and sending the retrieved documents along with the retrieved non-document specifications.

56. The computer-readable medium of claim 52 wherein non-document specifications are associated with bottommost categories.

57. The computer-readable medium of claim 52 wherein non-document specifications are associated with bottommost and non-bottommost categories.

58. The computer-readable medium of claim 52 wherein non-document specifications include web site and expert specifications.

59. The computer-readable medium of claim 52 wherein, when the received category is a non-bottommost category, retrieving non-document specifications associated indirectly with the non-bottommost category.

60. The computer-readable medium of claim 52 wherein, when the received category is a non-bottommost category, retrieving only non-document specifications associated directly with the non-bottommost category.

61. The computer-readable medium of claim 52 wherein the non-document specification includes a URL for a web site.

62. The computer-readable medium of claim 52 wherein the non-document specification includes a name of an expert.

63. The computer-readable medium of claim 52 wherein the non-document specification includes a URL of a web page containing information relating to an expert.

64. The computer-readable medium of claim 52 wherein the sending includes sending web site specifications, expert specifications, and documents associated with the received category via a single web page.

65. A computer system for providing access to non-document specifications based on a hierarchy of documents, comprising:
means for receiving a category within the hierarchical organization;
means for retrieving non-document specifications associated with the received category, the non-document specifications being hierarchically organized into categories based on a hierarchical organization of documents; and
means for sending the retrieved non-document specifications associated with the received category.

66. The computer system of claim 65 wherein the non-document specifications include web site specifications.

67. The computer system of claim 65 wherein the non-document specifications include expert specifications.

68. The computer system of claim 65 wherein non-document specifications are associated with bottommost categories.

69. The computer system of claim 65 wherein non-document specifications are associated with bottommost and non-bottommost categories.

70. The computer system of claim 65 wherein non-document specifications include web site and expert specifications.

71. The computer system of claim 65 wherein the non-document specification includes a URL for a web site.

72. The computer system of claim 65 wherein the non-document specification includes a name of an expert.

73. The computer system of claim 65 wherein the non-document specification includes a URL for a web page containing information relating to an expert.

74. The computer system of claim 52 wherein the means for sending includes means for sending web site specifications, expert specifications, and documents associated with the received category.

75. A method for organizing web sites based on an organization of documents, the method comprising:
providing the organization of the documents, the organization having categories;
receiving specifications of a plurality of web sites; and
assigning each web site to a category of the organization of documents so that web sites can be located based on the organization of documents.

76. The method of claim 75 including
receiving a category; and
in response to the receiving the category, providing a specification of a web site assigned to the received category.

77. The method of claim 75 wherein the organization is hierarchical.

78. The method of claim 77 wherein, when the received category is a non-bottommost category, providing a specification of a web site assigned directly to that received category.

79. The method of claim 77 wherein, when the received category is a non-bottommost category, providing a specification of a web site assigned indirectly to that received category.

80. The method of claim 75 wherein the specification of a web site includes a URL.

81. The method of claim 75 wherein experts are also assigned to categories.

82. A method for organizing experts based on an organization of documents, the method comprising:
providing the organization of the documents, the organization having categories;
receiving specifications of a plurality of experts; and
assigning each expert to a category of the organization of documents so that experts can be located based on the organization of documents.

83. The method of claim 82 including
receiving a category; and
in response to the receiving of the category, providing a specification of an expert assigned to the received category.

84. The method of claim 82 wherein the organization is hierarchical.

85. The method of claim 84 wherein, when the received category is a non-bottommost category, providing a specification of an expert assigned directly to that received category.

86. The method of claim 84 wherein, when the received category is a non-bottommost category, providing a specification of an expert assigned indirectly to that received category.

87. The method of claim 82 wherein the specification of an expert includes a URL for a web page containing information relating to the expert.

88. The method of claim 82 wherein web sites are also assigned to categories.
